(19) United States
(12) Patent Application Publication
(10) Pub. No.: US 2009/0008810 A1
(43) Pub. Date: Jan. 8, 2009

(54) Compression Moulding Apparatus and Method for Forming Plastics Objects

(76) Inventors: Fiorenzo Parrinello, Medicina (IT); Zena Zuffa, Borgo Tossignano (IT); Alessandro Balboni, Granarolo dell'Emilia (IT); Maurizio Borgatti, Imola (IT)

Correspondence Address: NIXON & VANDERHYE, PC, 901 NORTH GLEBE ROAD, 11TH FLOOR, ARLINGTON, VA, 22203, US

(21) Appl. No.: 11/664,917

(22) PCT Filed: Sep. 9, 2005
(86) PCT No.: PCT/IB05/02670

§ 371 Date: Apr. 9, 2007

(30) Foreign Application Priority Data
Oct. 12, 2004 (IT) RE2004A000128

(51) Int. Cl. B29C 45/80

(52) U.S. Cl. 264/40.5; 425/150

(57) ABSTRACT

A method comprises compression-moulding plastics to obtain objects by a moulding apparatus, said moulding apparatus being provided with a punch device and with a die device, said die device comprising a die body and a bottom element mutually cooperating to define a portion of a forming cavity, said moulding comprising reciprocally moving said die device and said punch device, there being furthermore provided driving said bottom element independently of said punch device and of said die device; an apparatus for compression-moulding plastics to obtain objects comprises a die device provided with a die-body device and with a bottom-element device mutually cooperating to define a portion of a forming cavity device, fluid-operating means arranged to reciprocally move said bottom-element device and said die-body device and a passage device arranged to convey said fluid-operating means, said passage device comprising a throttle device.

The present invention relates, in general, to compression-moulding of objects in polymers by pressure coupling of a punch with a closed-cavity die, loaded with a dose of polymers, the dose being first dispensed outside the die and being subsequently inserted into the cavity of the die.

A forming mould has a die with a lower part that is suitable for forming the lower part of the external surface of the object, the internal surface of which is formed by a lower end portion and by an axially elongated side portion.

The dose, both in the substantially molten state and in the more or less viscous state, is dispensed outside by the dispensing outlet whilst the latter is in a position outside the die cavity and is then inserted inside the die.

During insertion, the dose comes into contact with the side zone of the die cavity to thus prevent the dose descending with difficulty or incorrectly or not at all within the die. For these reasons, it is attempted to create doses having a diameter noticeably narrower than the minimum diameter section of the die cavity; consequently, the height of the dose, if the latter has a sufficiently viscous consistency, may be excessive in relation to the axial dimension of the die cavity and the dose therefore protrudes in an unacceptable manner from the die, preventing correct execution of the operations, in particular preventing correct closure of the mould after its components have moved into contact with each other.

Furthermore, the dose may remain stuck to the side wall of the die before reaching the base thereof and therefore protrudes, also in this case, in an unacceptable manner outside the die.

Other drawbacks still may occur if the punch operates by penetrating in a significant manner inside the cavity of the mould; in this case the punch, by deforming the dose, may produce a raising of the upper parts of the latter with exiting from the top of the cavity before the mould has been completely closed.

Other problems of containing the dose occur if the die consists of at least two separate components, an upper and a lower component, that are assembled together after the dose has been inserted. In this case, an operating step occurs in which the dose is contained inside only the lower part of the die and it is thus necessary that this lower part id designed in such a way that it has a height and a capacity that are sufficient to adequately contain the dose and prevent, as said above, that the dose protrudes in an unacceptable manner outside the die, preventing the mould from closing properly. An object of the present invention is in general to solve said technical problems.

A typical application of the invention, even if not exclusive, is forming preforms (semifinished products) in polymers intended for subsequent creation (typically by stretch blow moulding) of containers in polymers, forming of the preform being achieved by pressure insertion of a punch (male mould element) inside a hollow die (female mould element) loaded with a dose of fluid, semi-molten or liquid matter, in particular a thermoplastic resin, the preform comprising a neck, in the upper position, provided with projections and a hollow body joined to the neck.

In this case, the invention relates to a forming unit used in a rotating carousel machine (typically moved continuously), typically operating with a plurality of equal forming units that are actuated in sequence. “Driving in sequence” means here that each angular position of a unit (or of a plurality of units operating simultaneously) is matched by an unequivocal operating configuration of the unit (or of the plurality of units and, following the rotation of the carousel, each unit performs an operating cycle; this operating cycle can, furthermore, be performed following a complete revolution of the carousel or by fractions of a revolution.

According to said typical application, the unit in question comprises a mould having: an upper die part, having an internal surface suitable for forming the external surface of the upper neck, divided into at least two sectors suitable for being moved away from each another for extracting the preform, a lower die part having an internal surface suitable for forming the external surface of the hollow body, and a punch having an external surface suitable for forming the internal surface of the preform, the cavities of said upper and lower die parts being suitable, when operationally associated with each other, for forming, together with the punch, the mould cavity.

According to the disclosed typical application, said technical problems connected with containing the dose in the die are amplified.

The particularly fin-shaped conformation of the surface of the upper part of the die tends to retain the dose that comes into contact with it.

Furthermore, as the mould is rotated at great speed, centrifugal thrusts exist that tend to shift the trajectory of the dose that descends in the die in relation to the exactly vertical trajectory that is obtained in static conditions.

These factors force the dose to be made as thin as possible in relation to the diameters of the die cavity to prevent the doses from coming into contact with and remaining stuck to the die cavity.

Therefore, if the dose has a sufficiently viscous consistency, it has, because of the reduced diameter, an axial length (height) that is significant to the point that for some models it is greater than the height of the cavity into which it is inserted and then protrudes externally upwards. This involves problems and/or complications in the incorporation and jointing of the parts of the mould in the subsequent closing phase due to the fact that the dose may protrude outside the cavity, also in a radial direction, and thus hinder and prevent the correct operation of the mould.

Furthermore, for this typical application of the invention, owing to the high operating speeds of the rotating carousel machine, the speed at which the punch penetrates inside the die where it deforms the dose is very high (the forming operation takes a few tenths of a second); there is thus the danger that upper end parts of the dose are thrown outside the die cavity before it has been closed by the punch, with consequent serious irregularities and obstacles to the correct operation of the machine.

According to an embodiment of said typical application, in the first forming step, a dose (i.e. a body with preset mass) of polymers is inserted into the cavity of the lower part of the die whilst the upper die part is place above and at a distance from the lower part. Subsequently, the upper die part is moved towards and is thus associated with the upper edge of the lower die part in such a way as to create with the latter the complete cavity of the die and the punch is made to penetrate into this cavity.

In particular, for preforms with a relatively small mass, i.e. for making containers with relatively small capacity (e.g. less than about 0.3 litres) the mass of the neck is relatively great in relation to the mass of the hollow body and therefore the mass of the entire preform is relatively high in relation to the receptive capacity of the lower part of the die; it may thus happen that the dose is not contained completely within the cavity of the lower die part, whether it is in substantially liquid form or in the form of an elongated more or less viscous cylinder.

An object of the present invention is to overcome the drawbacks described above.

A second technical problem connected with said moulds, in particular where applied to a machine operating at high speed, arises from the fact that the dose inevitably has (small) differences in mass in relation to the preset value whereas the volume of the mould chamber, which has to be completely filled by the dose to form the preform, is kept exactly constant (with reference to the same mould); there is thus the problem of compensating for the imprecision of the mass of the dose produced during the dosage step.

Another object of the present invention is to provide a valid solution to this second technical problem.

Another drawback of the known apparatuses is that they do not enable it to be indicated whether the dose inserted into the mould is too big or too small in relation to a preset value. A further object of the invention is to provide an apparatus that is able to detect undesired operating faults that may occur during forming operations.

A still further object of the invention is to provide an apparatus that is able to form objects with greater precision.

In a first aspect of the invention, a method is provided comprising compression-moulding plastics to obtain objects by mould means, said mould means being provided with punch means and with die means, said die means comprising a die body and a bottom element mutually cooperating to define a portion of a forming cavity, said moulding comprising reciprocally moving said die means and said punch means, characterised in that it furthermore comprises driving said bottom element independently of said punch means and of said die means.

Owing to this aspect of the invention, it is possible to precisely control driving of the bottom element and consequently compression of the plastics.

In a version, the mould means can be completely closed before the bottom element is moved to the punch means, which prevents portions of plastics exiting the mould means.

In a further version, it is possible to start to drive the bottom element when a prevalent part of the punch means penetrates inside the die means, but before the mould means is completely closed. This enables the step of compression of the plastics to be accelerated.

In a still further version, the die means comprises a first component body—the aforementioned die body—and a second component body—the aforementioned bottom element—having internal surfaces that can be aligned in a complementary manner, i.e. that can be arranged together in such a way as to form a single substantially continuous surface that defines the entire internal surface of the die means in a position that is here called a forming position.

The internal surface of the second component body defines for its entirety, or for a considerable fraction thereof, the end portion of the internal surface of the die means. Furthermore, the second component body is movable in relation to the first component body between said forming position and a retracted position, in which its internal surface is placed far from the surface of the first component body in such a way as to increase the volume of the forming cavity of the die means.

Driving means is arranged to arrange said second component body in said retracted position in the loading step of a dose of polymers in the forming cavity of the die means and to take it to the forming position during the forming step.

The operation of the forming of preforms may occur in the steps listed here:
dispensing of a dose outside the die means;
inserting a dose into the forming cavity of the die means being the second component body in the retracted position;
subsequent insertion of punch means into the forming cavity of the die means;
shifting of the second component body to the forming position, this position not being reached until the punch means reaches the closing position of the mould means.

When the second component body is in the retracted position, the forming cavity of the die means has noticeably greater capacity than a lower part of a traditional die.

Furthermore, the forming cavity of the die means has a value volume that is variable and this can be suitably used to compensate for an error in dosing of the mass of the dose. Furthermore, in the forming operation, the mass of the dose fills the forming cavity relatively completely and evenly, without unacceptable tensions and imperfections, above all with regard to the top end of the neck that during forming is the most critical zone.

In a second aspect of the invention, an apparatus is provided for compression-moulding plastics to obtain objects, comprising die means provided with die-body means and with bottom-element means mutually cooperating to define a portion of forming cavity means, fluid-operating means arranged to reciprocally move said bottom-element means and said die-body means and passage means arranged to convey said fluid-operating means, said passage means comprising throttle means.

Owing to this aspect of the invention, it is possible to control a speed with which the bottom-element means is moved in relation to the die-body means.

In particular, the bottom-element means can be advanced at a preset speed—depending on the type of plastics that has to be moulded—in such a way as not to make the plastics deteriorate.

In a third aspect of the invention, an apparatus is provided, comprising mould means arranged for compression-moulding plastics to obtain objects, said mould means being provided with half-mould means and with actuating means for moving said half-mould means, characterised in that it furthermore comprises detecting means arranged for detecting positions of said half-mould means.

Owing to this aspect of the invention, it is possible to monitor the shift of the half-mould means during operation of the apparatus.

In particular, it is possible to detect possible operating faults of the actuating means.

In a fourth aspect of the invention, an apparatus is provided, comprising mould means arranged for compression-moulding plastics to obtain objects, said mould means being provided with die-body means and with bottom-element means reciprocally movable and mutually cooperating to define a portion of forming cavity means, and furthermore comprising detecting means arranged for detecting positions of said bottom-element means relative to said die-body means.

Owing to this aspect of the invention, from monitoring the ways of shifting in relation of the bottom element means in relation to the die-body means, it is possible to obtain information on the actual quantity of plastics that has been inserted inside of the die-body means and accordingly establish—even before opening of the mould means—if a moulded object can be reasonably considered to be qualitatively acceptable or whether on the other hand it has to be rejected.

In particular, it is possible to detect whether the aforementioned quantity of plastics substantially corresponds to a preset value, or if it differs by more or less than the preset amount.

The invention may be better understood and implemented with reference to the attached drawings that show some embodiments thereof by way of non-limitative example, in which:

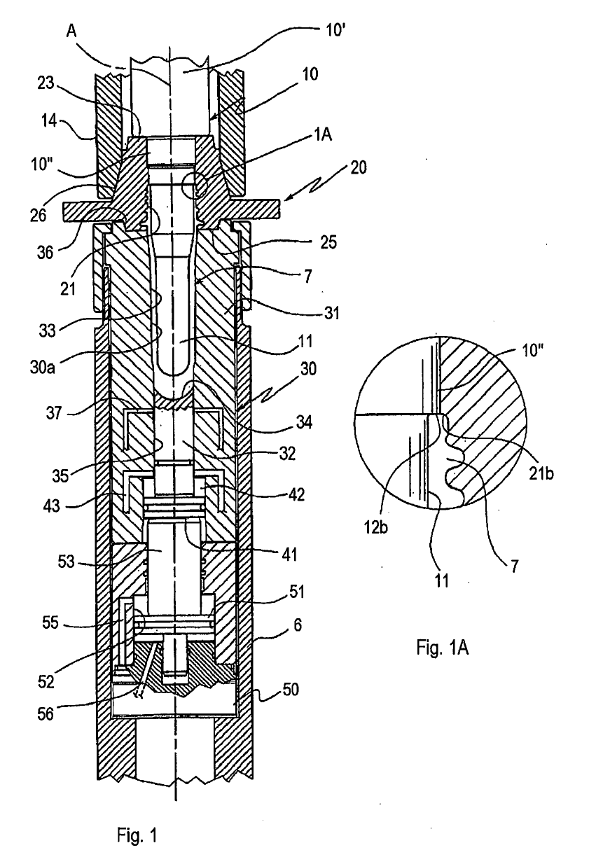

FIG. 1 is an axial section of a forming mould (the cavity 7 of the mould is shown to be empty);

FIG. 1A is an enlarged detail of FIG. 1;

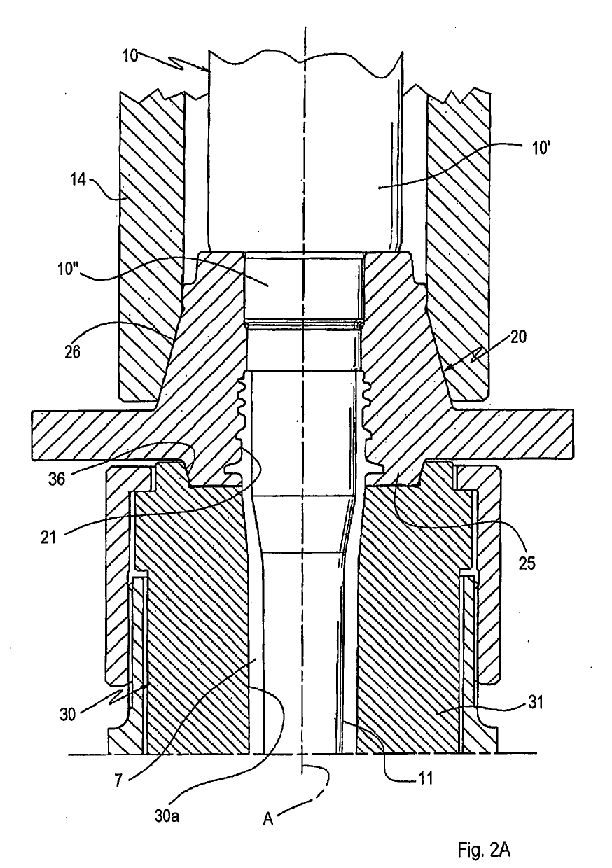

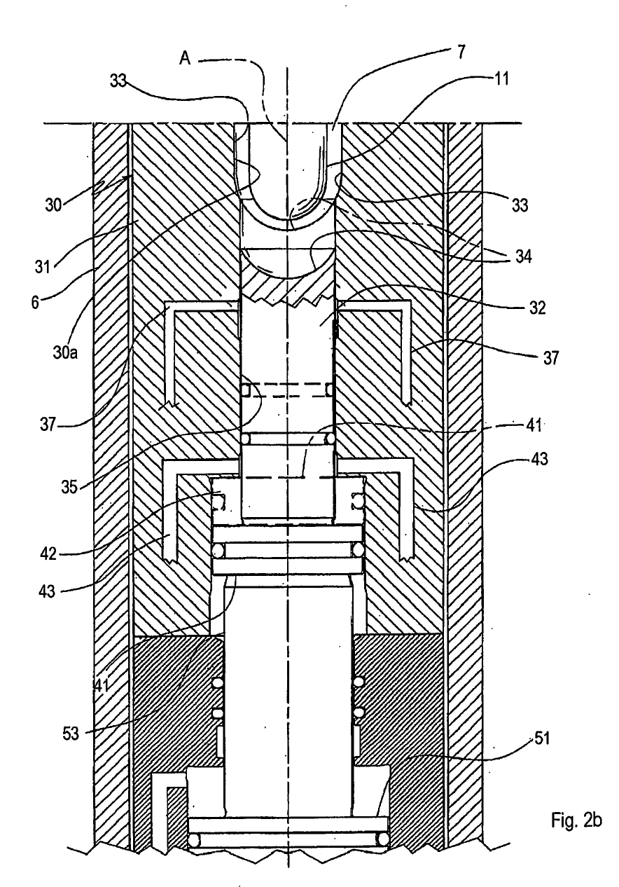

FIG. 2A shows on an enlarged scale the upper portion of FIG. 1;

FIG. 2B shows on an enlarged scale the lower portion of FIG. 1;

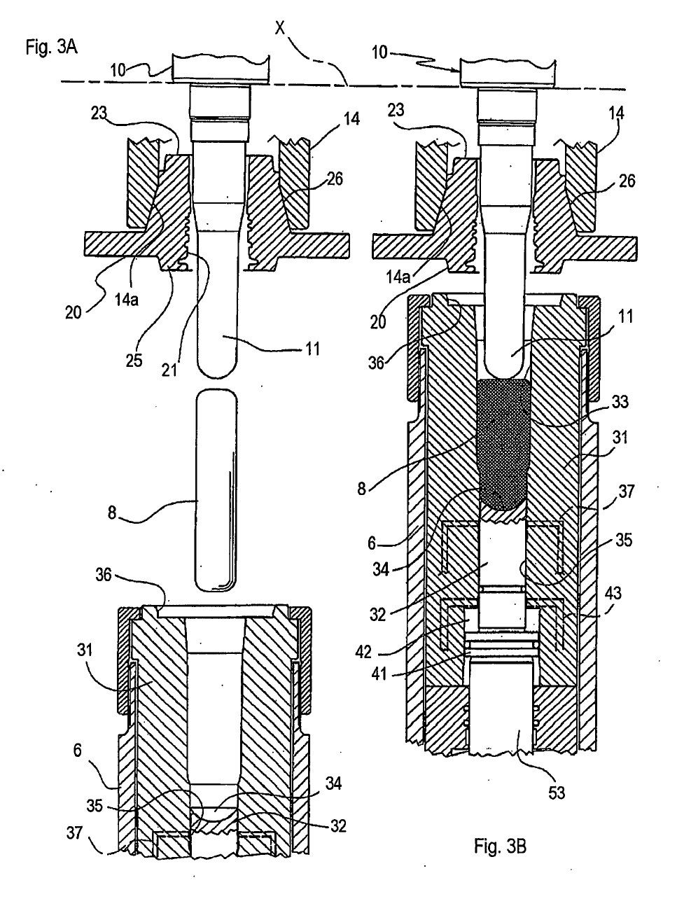

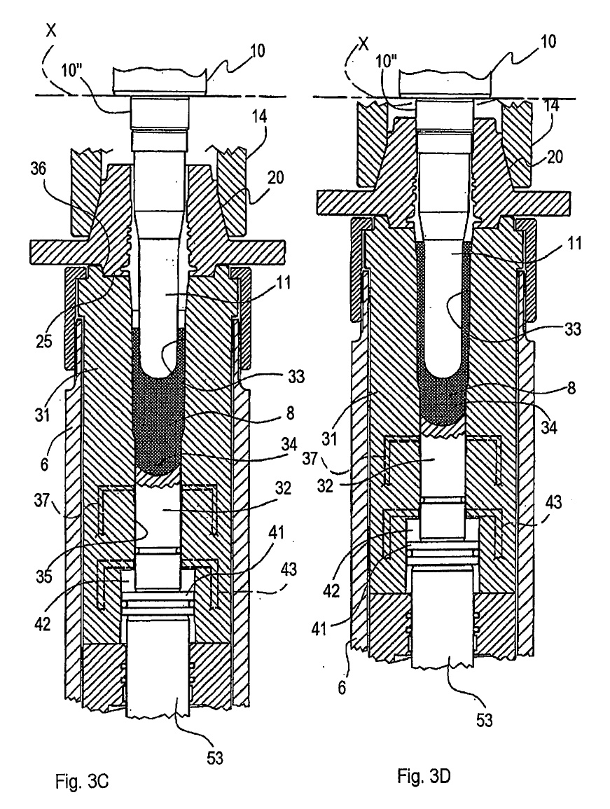

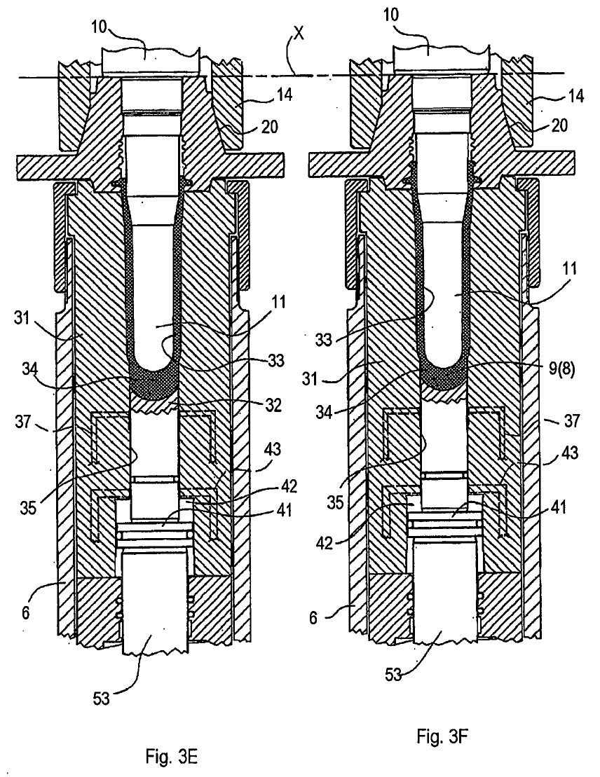

FIGS. 3A-3G show the mould in FIG. 1 in a succession of steps during the formation of a preform;

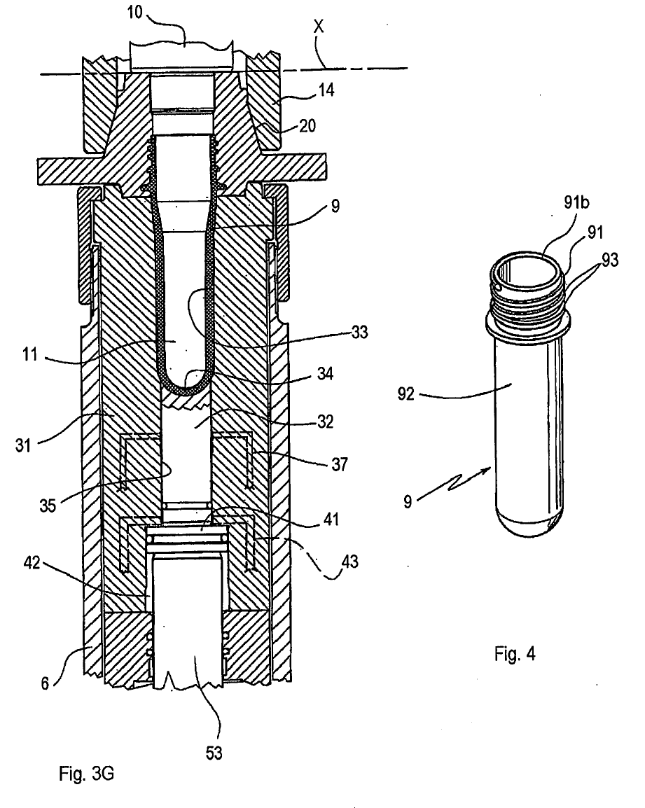

FIG. 4 shows an example of a preform that is obtained with the invention;

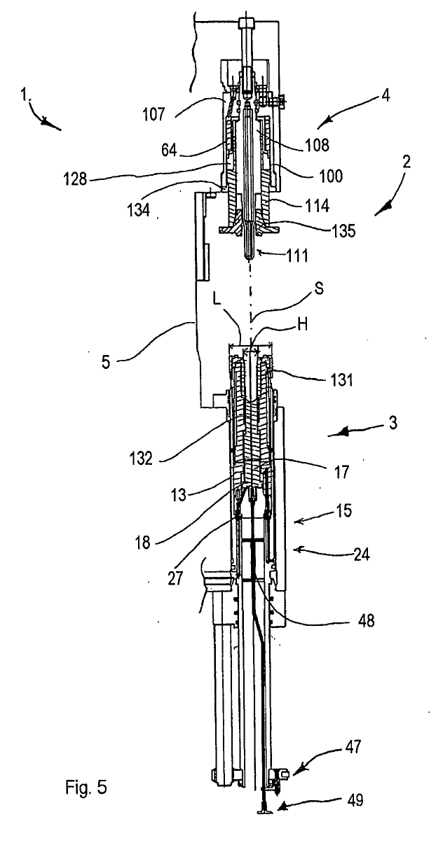

FIG. 5 is a fragmentary and partially sectioned side view of an apparatus for forming objects shown in a first operational configuration;

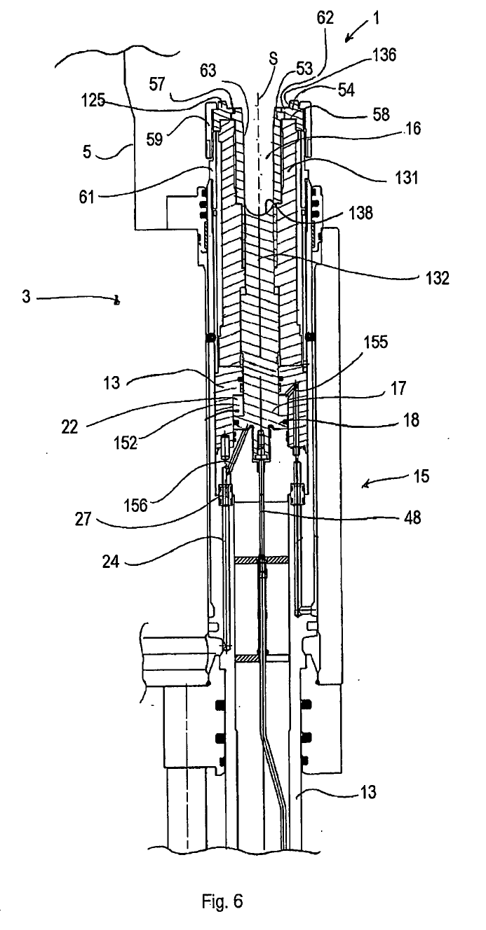

FIG. 6 is a detail of FIG. 5;

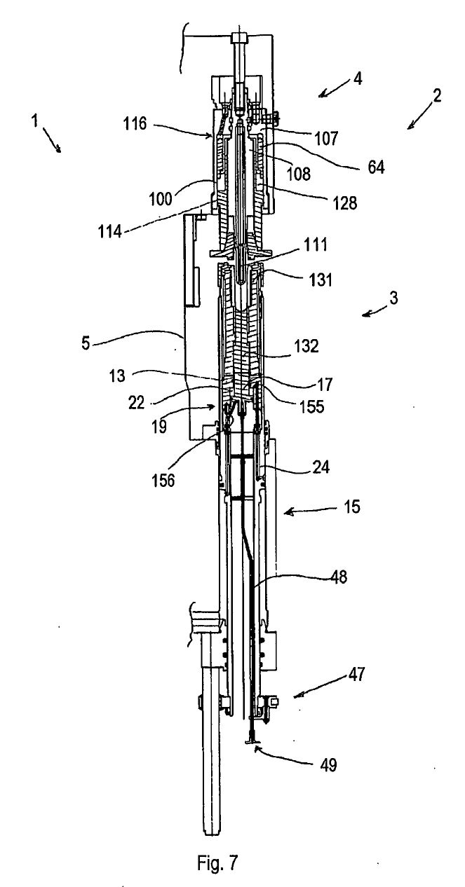

FIG. 7 is a fragmentary and partially sectioned side view of the apparatus in FIG. 5, in un second operational configuration;

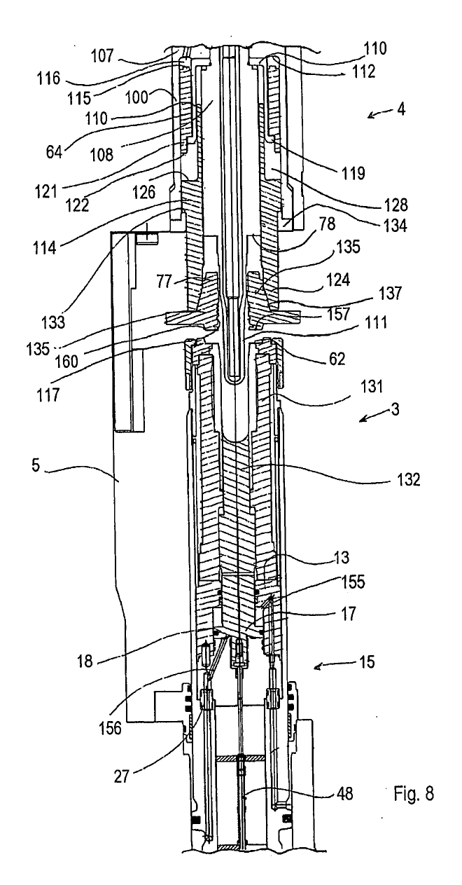

FIG. 8 is a detail of FIG. 7;

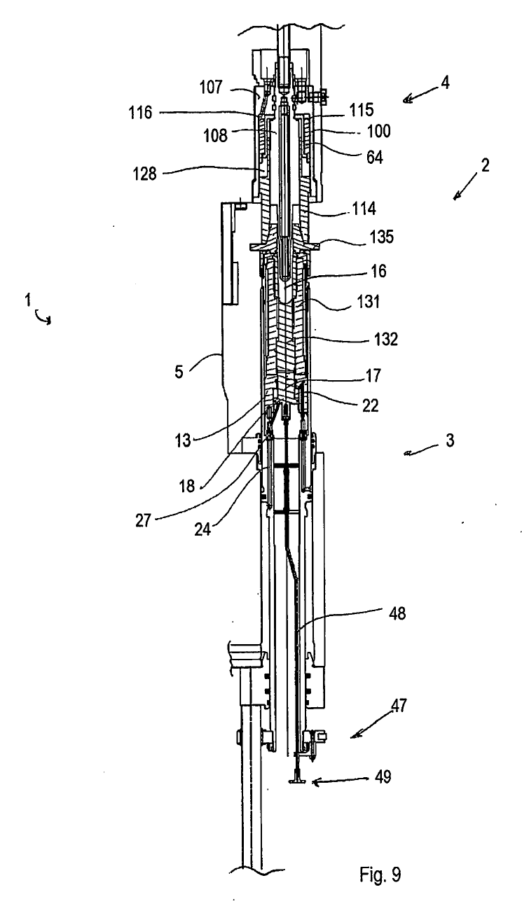

FIG. 9 is a fragmentary and partially sectioned side view of the apparatus in FIG. 5, in a third operational configuration;

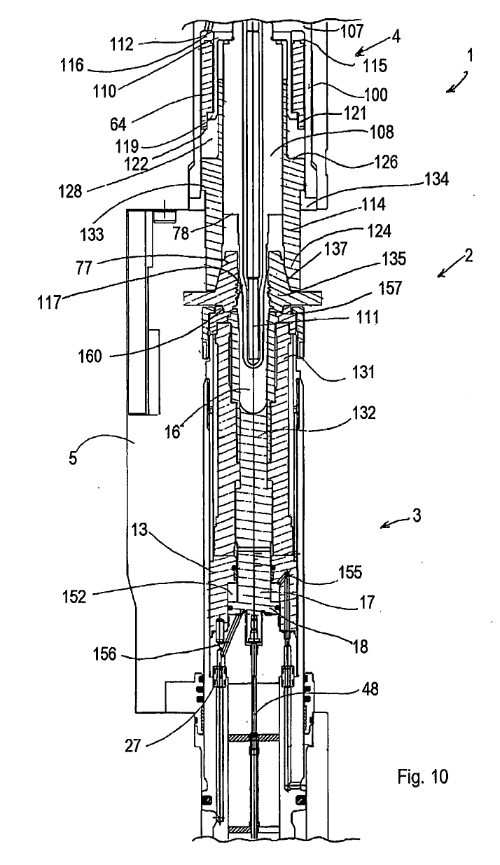

FIG. 10 is a detail of FIG. 9;

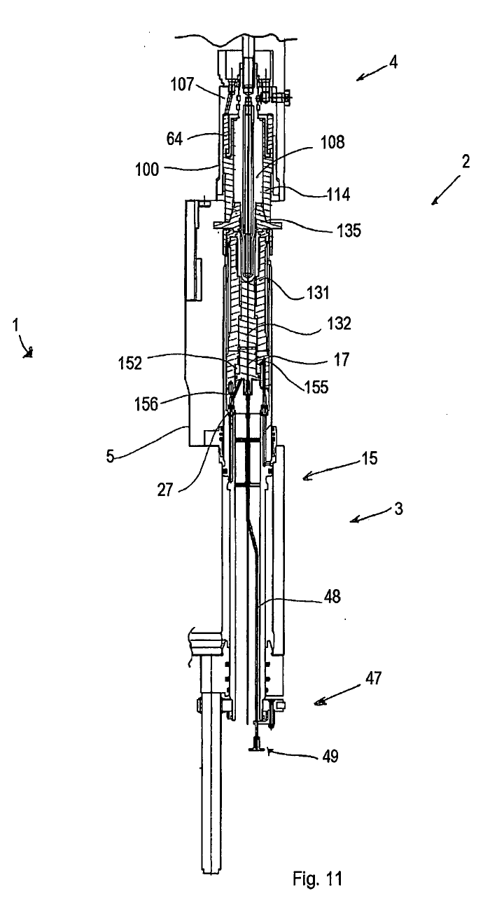

FIG. 11 is a fragmentary and partially sectioned side view of the apparatus in FIG. 5 in a fourth operational configuration;

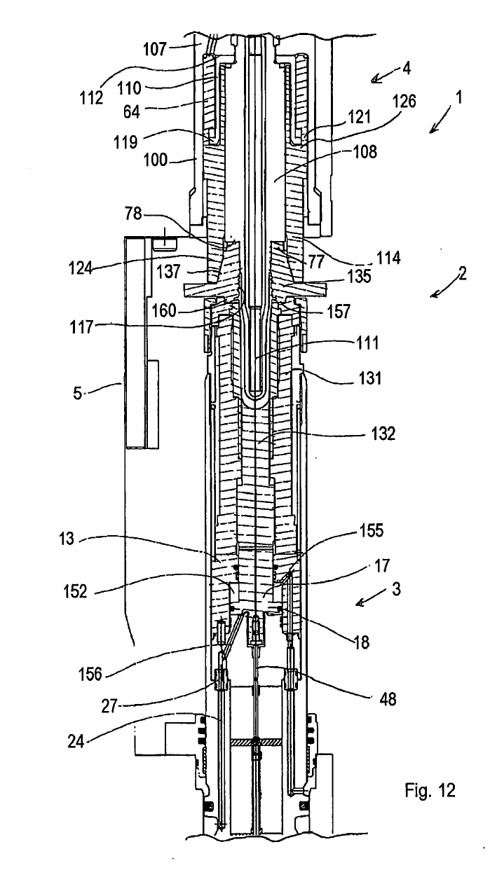

FIG. 12 is a detail of FIG. 11;

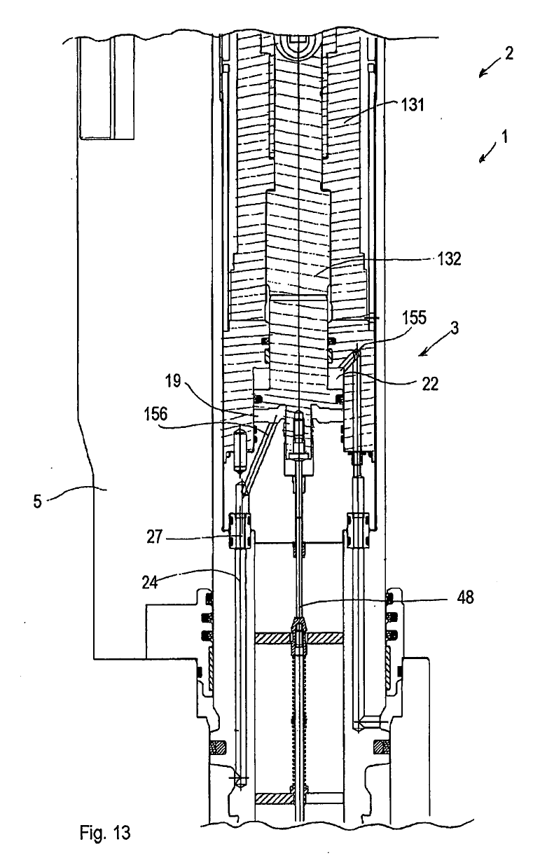

FIG. 13 is a fragmentary and partially sectioned side view of the apparatus in FIG. 5 in a fifth operational configuration;

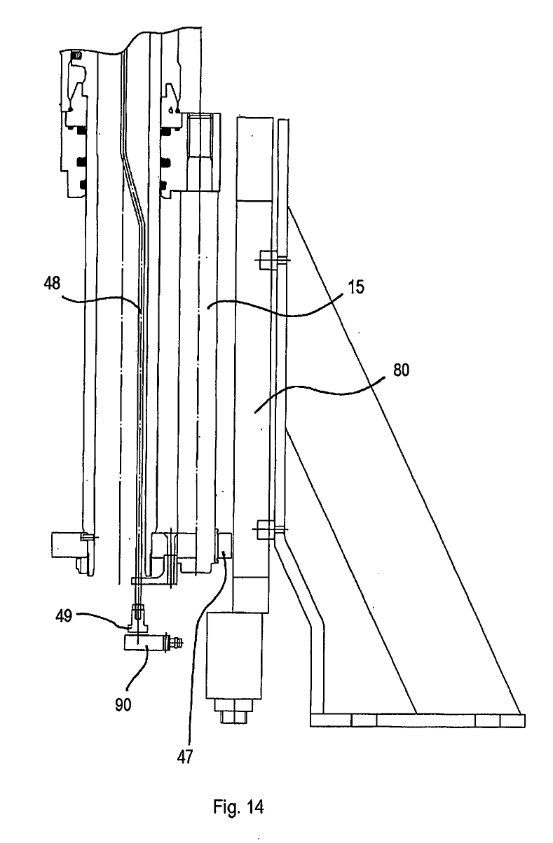

FIG. 14 is a fragmentary and partially sectioned side view of the apparatus in FIG. 5 showing detecting means arranged for detecting the position of half-mould means and further detecting means arranged for detecting the position of a movable bottom element of the half-mould means;

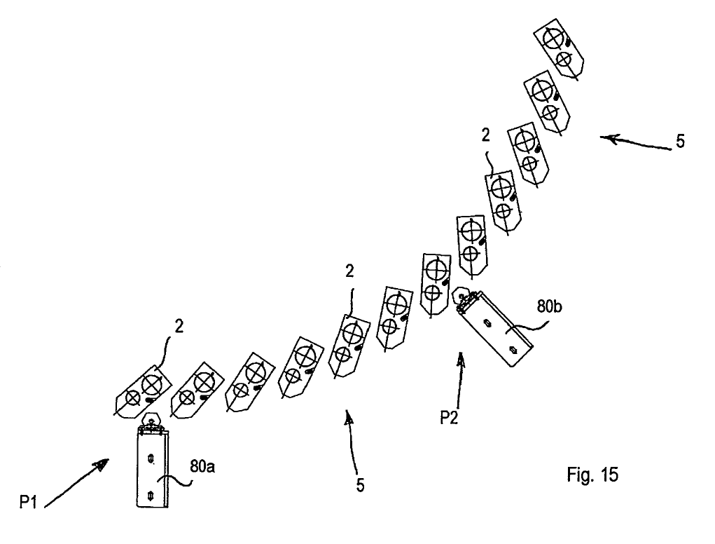

FIG. 15 is a schematic and fragmentary plan view of the carousel in FIG. 15 showing the detecting means;

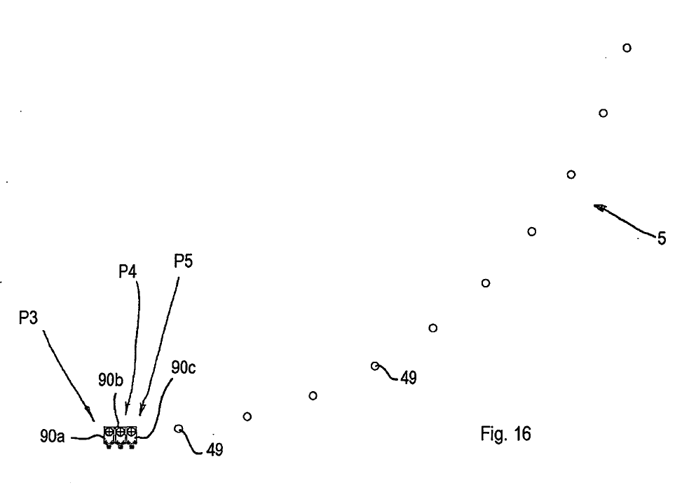

FIG. 16 is a view like the one in FIG. 15 showing the further detecting means;

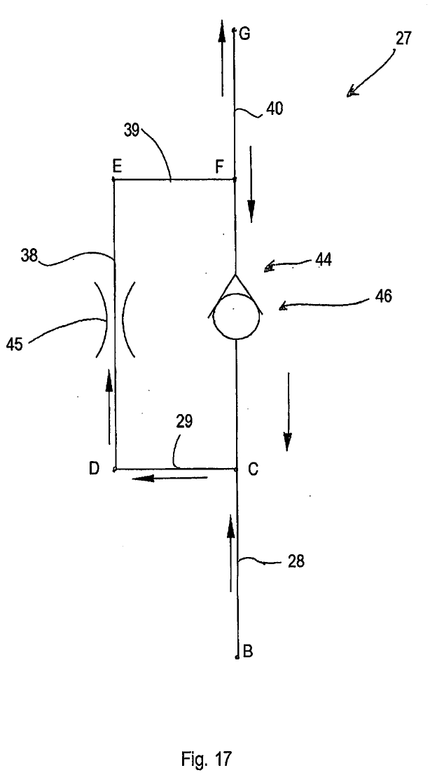

FIG. 17 is a diagram of a throttle device with which the apparatus in FIG. 5 is provided;

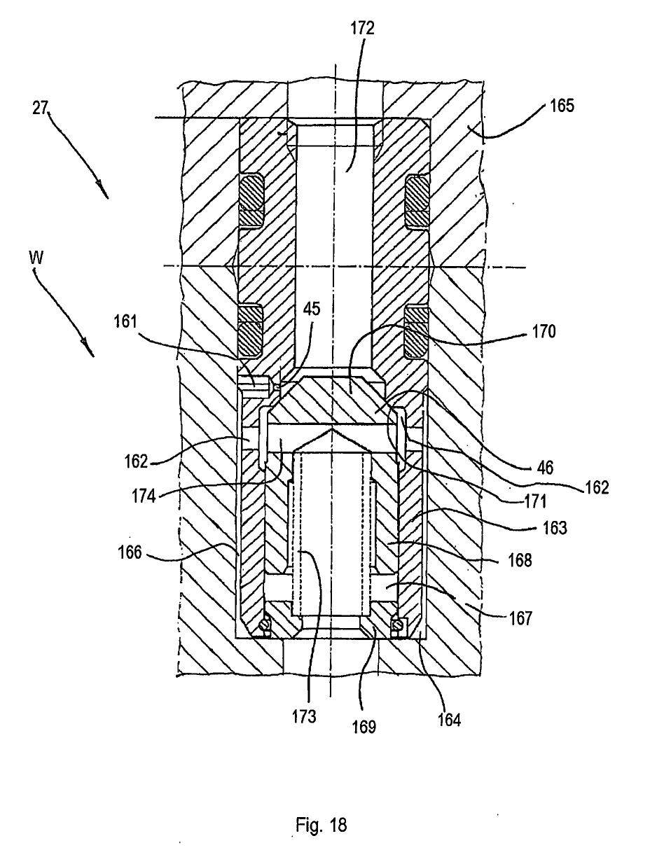

FIG. 18 is a section taken along a longitudinal plane of a version of the throttle device in FIG. 17.

According to the invention a unit is provided comprising a mould having a die and punch. Together, the punch and the die cavity create a closed chamber 7 in which, following compression exerted in the mould, the object is given a shape.

According to the typical application of the invention, the object that it is desired to mould is a preform 9 intended for the subsequent creation (typically by stretch-blow moulding) of containers.

An example of a preform that it is desired to obtain according to the invention is illustrated in FIG. 4. This preform, which is indicated by 9, is for making bottles in thermoplastic PET resin and comprises a neck 91, having the end shape provided in the bottle, and a hollow body 92 that is intended, during the step of creating the bottle, to form the containing body thereof. In general, the neck 91 is provided with projections that for example define a thread 93 protruding radially outwards and which is suitable for receiving a usual screw cap. The hollow body 92 on the other hand has a continuous external surface that is generally semi-cylindrical (slightly tapered towards the bottom to facilitate extraction) and terminating at the lower end with a more or less spherical cover.

The object (in particular, the preform 9) is obtained with a compression-moulding procedure by means of pressure-insertion of a punch 11 (male element of the mould) inside the cavity of a hollow die (female element of the mould) loaded with a dose 8 of polymers with a preset mass (the same mass as that of the preform that it is desired to be obtained) of (solid, pasty or liquid) material, in particular a thermoplastic resin.

The forming machine that uses the unit according to the invention is typically of the rotating carousel type, typically operating continuously, and typically operates with a plurality of equal forming units that are driven in sequence.

The figures illustrate only a generic unit according to the invention. The machine is on the other hand not shown, being in itself prior-art.

According to the embodiment shown in the figures, the unit in question comprises a mould having a die and punch 11. Together, the punch 11 and die cavity create a closed chamber 7 in which the preform 9 is moulded. The die cavity gives shape to the external surface of the preform whereas the external surface of the punch 11 gives shape to the internal surface of the preform.

The mould die consists of an upper part 20 and of a lower part 30. The upper part 20 of the die has an internal surface, or shaping surface 21 that is suitable for shaping the external surface of the upper neck 91 of the preform divided into at least two sectors or movable die parts, suitable for being radially distanced from each other to enable extraction of the preform 9. The lower part 30 of the die has an internal surface 30a that is suitable for shaping the external surface of the hollow body 92 of the preform, which comprises a lower end portion and an almost cylindrical side portion.

The two upper 20 and lower 30 parts of the die are separated from each other during the loading step of the dose 8, which dose 8 is inserted into the cavity of only the lower part 30 of the die; the internal surfaces 21 and 30a of said upper 20 and lower 30 parts of the die are suitable, when they are operationally associated with each other, to form the entire die cavity.

According to the invention, the lower part 30 of the die comprises a first component body 31, or die body, and a second component body 32, or movable bottom element, having internal surfaces, respectively 33 and 34, that can be aligned in a complementary manner to define, together, the entire internal surface 30a of the lower part 30 of the die. The first component body 31 has a through opening 35, that leads into the die cavity, the internal surface of which consists of parallel generatrixes; the second component body 32 has a side surface that matches the surface of the through opening 35, giving rise to a sealing coupling and with the possibility of sliding in the direction of the generatrixes. According to the embodiment shown in figures, the cavity of the lower part 30 of the die has an axial geometrical shape. In particular the entire die cavity has a semi-cylindrical general shape and the internal surface 30a of the lower part 30 of the die has an axial symmetrical shape (around a vertical A axis) consisting of a semi-cylindrical portion to which a lower portion is joined that substantially has the shape of a spherical cover. Obviously, such shapes, may be varied; in particular, the shape of the lower portion may be more or less flat, rather than having the shape of a spherical cover.

The first component body 31 of the lower part 30 of the die has a general cylindrical shape with an axis coinciding with the axis A and said through opening 35 also has a cylindrical shape that is also coaxial with the axis A.

As a result, also the second component body 32 has a side surface with a general cylindrical shape and its internal surface 34 defines the central and lower portions of the internal surface 30a of the lower part 30 of the die. The second component body 32 is movable in relation to the first component body 31 between a forming position (illustrated in FIG. 3G and with a broken line in FIG. 2B), in which its internal surface 34 is located on said position aligned on the internal surface 33 of the first component body 31, and a retracted position in which its internal surface 34 is placed far off, lower down, in relation to the internal surface 33 of the first component body 31 in such a way as to create a volume increase of the cavity in relation to the volume in the forming position.

An “aligned” position is defined as one in which the two surfaces 33 and 34 are arranged in such a way that there is not substantially discontinuity but are arranged as a single surface not separated into two parts. It should also be pointed out that the forming position does not necessary coincide with the position in which the surface 34 of the second component body 32 is the exact geometrical continuation of the surface 33 of the first component body 31 (as illustrated by broken lines in FIG. 2B) but, as disclosed below, it deviates from the latter in a variable manner, in function of the error of the mass of the dose in relation to the preset design value. The forming position is thus a variable position (that in practice changes at each forming cycle) near said geometrical continuation position illustrated in FIG. 2B. Geometrical discontinuity thus occurs that is of such an extent as to be practically insignificant.

The internal surface 34 defines entirely, or for a considerable fraction thereof, the lower end portion of the internal surface of the lower part of the die. A fraction is defined as a percentage of the surface and a “considerable fraction” is defined as a percentage that is sufficient to define when the second component body 32 is in the retracted position, a noticeable increase in volume that is such as to receive the lower part of the dose 8. In practice, said fraction will be at least equal to 50% of the surface of the transverse section of the cavity.

Obviously, inside and/or outside the first component body 31 and possibly the second component body 32 suitable channels can be provided (per se of the known type and not illustrated here) to cool parts of the mould and therefore of the preform.

The unit in question furthermore comprises the driving means suitable for arranging the second component body 32 in said retracted position (illustrated by a continuous line in FIG. 2B) in the loading step of a dose of polymers in the cavity of the lower part of the die and taking it to the forming position (illustrated in FIG. 3G and with a broken line in FIG. 2B) during the forming step.

In particular, said driving means comprises at least a piston-cylinder linear actuating means.

According to the embodiment shown in the figures a linear actuating means is provided comprising a first piston 41, or auxiliary actuator, coaxial with the axis A, applied (on contact) directly to the lower end portion of the second component body 32 (in particular made integrally therewith), sealingly movable within a chamber 42 obtained in the lower zone of the first component body 31. A channel 43, connected to a source (not illustrated in the figures) of an operating fluid (e.g. compressed air) takes this fluid inside the upper zone of the chamber 42 in order to produce the descent downwards of the second component body 32 and thus to take it to a retracted position.

Advantageously, said operating fluid may consist of a cooling fluid that is supplied pressurised, thereby performing the further function of conditioning (cooling) the component body 32 and by it, the object that is moulded.

Furthermore, a second double-action actuating means 50 is provided that is arranged below the lower part 30 of the die and is joined to it, having a piston 51 that is movable inside a chamber 52, to which a stem 53 is joined that pushes on contact with the lower base of the piston 41. An upper channel 55, connected to a source (not illustrated in the figures) of operating fluid (e.g. oil, nitrogen, etc.), takes the fluid to the upper zone of the chamber 52 to cause the descent of the piston 51; this descent is preferably carried out autonomously from the descent of the second component body 32 produced by the channel 43 and possibly before the latter.

Furthermore, a lower channel 56 connected to a source (not illustrated in the figures) takes a high-pressure operating fluid (e.g. oil, liquid nitrogen, etc.) inside the lower zone of the chamber 52 to cause the ascent of the piston 51 and consequently of the second component body 32 and thus take it to the forming position.

The upper part 20 of the die is of the traditional type and is divided into at least two sectors that are complementary to one another (not illustrated in detail in the figures) suitable for being moved away in a radial direction to enable the extraction of the preform; when they are in a closed portion, these sectors are intimately adherent to one another by respective conjugate separation surfaces and substantially placed on axial planes.

According to the embodiment shown in figures, the lower face of the upper part 20 of the die has a central annular protrusion 25, directed downwards, having a frustum-conical convex external surface, suitable for matching an equal concave surface 36 provided on the upper end portion of the first component body 31.

When the upper part 20 of the die is coupled with the lower part 30 of the die, said central protrusion 25 couples with the surface 36, in such a way that, following an axial thrust that tends to join the parts 20 and 30 of the die, a coupling is created that prevents the radial shift of the sectors that form the upper part 20 of the die. Furthermore, in this configuration, the internal surfaces 21 and 30a of the two parts of the die are aligned on each other and give rise to a total die surface that gives shape to the external surface of the preform.

The punch 11 is firmly fixed to an upper body 10 with which a single body is made and of which it defines the lower end portion, the one that gives shape to the internal surface of the preform. In detail, the upper body 10 comprises a cylindrical upper portion 10′, the lower end of which forms an abutment suitable for abutting on the upper end 23 of the upper part 20 of the die, and a lower portion 10″ to which the proper punch 11 is joined below.

The upper surface 91b of the extreme upper edge of the neck 91 of the preform is partially formed by a narrow upper surface 21b, facing downwards, that ends with a substantially horizontal tangent that defines the upper border of the internal surface 21 of the upper part 20 of the die, and is partially formed by a narrow upper surface 12b, facing downwards and ending with a substantially horizontal tangent, that defines the upper border of the external surface of the punch 11, bordering with the lower end of the lower portion 10″ (see FIG. 1A).

When the mould is in the closed position, i.e. the punch 11 and the parts 20 and 30 of the die are reciprocally coupled in such a way that the cavity of the mould (chamber 7) defines the shape of the preform, the two said upper surfaces 12b and 21b are aligned on each other.

In FIGS. 3A to 3G a succession of steps is illustrated according to a forming method that is the subject of the invention.

The moving towards one another of the components of the mould is achieved, according to the embodiment shown in figures, following lifting of the lower part 30 of the die, operated by means of a lower tool 6 only the upper end portion of which is perceived in the figures; the upper body 10 and the punch 11 are on the other hand stationary. In the Figures from 3A to 3G X indicates a horizontal reference axis that remains fixed, passing through the lower abutment of the upper portion 10′ of the body 10.

What is important is the relative moving towards one another; this can be obtained, as an alternative after the downward movement of the upper body 10, possible together with an upward movement of the lower tool 6.

In an initial step (illustrated in FIG. 3A) a dose 8 is inserted into the cavity of the lower part 30 of the die, whereas the second component body 32 is in the retracted position.

Subsequently, following an upward shift of the lower part 30 of the die (FIG. 3B) produced by the tool 6, the upper end 30 of this die couples with the lower end of the upper part 20 of the die (position illustrated in FIG. 3C) and the punch 11 starts to penetrate the die cavity starting to deform the dose 8. The sectors that form the upper part 20 of the die are radially closed in position by an upper annular body or maintaining sleeve 14 that is associated with the punch 11 and is vertically movable in relation thereto, the lower end portion of which has a frustum-conical concave surface 14a that matches a complementary side surface 26, or external and upper frustum-conical surface of the upper part 20 of the die, which is also frustum-conical.

Subsequently, (FIG. 3D) the punch 11 continues to penetrate (always following a shift upwards of the lower tool 6) inside the die cavity until it produces the complete closure of the mould that occurs when the two surfaces 12b and 21b are aligned (position illustrated in FIG. 3E).

Subsequently, the upward shift of the second component body 32 (FIG. 3F) is also carried out by means of the disclosed driving means, until taking the internal surface 34 thereof to the forming position, namely aligned on the internal surface 33 (position illustrated in FIG. 3G).

In the step in which the die receives the dose 8, the second component body 32 is in the retracted position and as its internal surface 34 is relatively great, the capacity of the lower part 30 of the die is noticeably greater than that of a traditional die and thus enables a dose having relative great mass and/or height to be received that would not be otherwise receivable.

This advantageous aspect also operates in the forming step when the punch penetrates, deforming it, inside the mass of the dose; in fact, owing to the presence of increased volume located at the lower end of the cavity, into which the dose flows, the higher parts of the latter keep at a sufficient distance from the upper limit of the cavity 7 of the die, whereas the punch descends into the cavity (FIGS. 3C and 3D) until the cavity 7 has shut completely (FIG. 3E). This prevents part of the dose from being able to be ejected outside the die cavity.

In the embodiment illustrated in FIGS. 3A-3G, the disclosed shift of the second component body 32 substantially starts when the punch 11 reaches the closing position (FIG. 3E). Alternatively, this movement of the second component body 32 can start before the mould closes; nevertheless always in such a way that said forming position is not reached before and is preferably reached after the punch has reached said closing position of the mould (FIG. 3E).

Once the disclosed final position (forming position—FIG. 3G) has been reached, preferably the second component body 32 is kept pressed against the material located in the cavity of the mould with a preset design pressure, for a period in which the material of the preform undergoes significant cooling with consequent reduction of the volume following reduction of the specific volume.

Design pressure is usually in the order of a few hundred bar; for example, the forming period of time between the phase 3B and the phase 3G is in the order of tenths of a second and the subsequent period of time in which the work pressure is maintained is a few seconds.

Another advantage that is achieved with the invention is that, if the mass of the dose 8 has an error in relation to a preset value, as happens in practice, the cavity of the mould is nevertheless filled perfectly, and at the desired design pressure (this aspect is important above all in relation to the neck 91, which is the most critical zone inasmuch as it is the zone that undergoes definitive forming).

In fact, at the end of the forming step the second component body 32 stops in a position (forming position) in which it is more or less distant from said position of exact geometrical continuation between the surfaces 33 and 34, and this in function of the size of the dose error (and also in function of the pressure with which it operates). The part of preform that absorbs variations in dose 8 mass is therefore the part formed from the surface 34 of the second component body 32; in practice, the lower end zone of the hollow body 92 of the preform has a greater or lesser thickness in relation to the design thickness in function of the fact that the dose has a greater or lesser mass than the preset mass.

And as, in the subsequent blow-moulding step (so called stretch-blow-moulding) the hollow body 92 is greatly dilated (whereas the neck 91 remains unchanged), the fact that the lower portion of the body has a thickness that is not exactly the same as design thickness is generally acceptable. Furthermore, the dose error is so small in relation to the dimensions of the object part in which it is absorbed that said difference between the actual thickness and design thickness is practically irrelevant and certainly acceptable. Still another advantage of the invention is that, as has been established experimentally, relatively uniform and regular filling of the cavity of the mould is obtained during forming with the result that the preform is devoid of irregularities and internal tensions of the non-acceptable, possible harmful type.

In the first component body 31 a channel 37 is obtained that leads into the cylindrical side surface of the second component body 32 and is connected with means (not illustrated in the figures) that is suitable for aspirating the air in the gap present between said side surface and the through opening 35. Through said channel it is possible to extract air from the cavity of the mould before and during forming.

Said channel 37 (or another parallel channel) can also be connected with means (not illustrated in the figures) that is suitable for providing a pressurised fluid, which means is actuated during the preform extraction step following forming. By sending a pressurised fluid to the channel 37 by this means, this fluid penetrates through said side surface and through the through opening 35 into the lower end zone of the die cavity between the surface 30a of the lower part of the die and the preform, causing or at least facilitating the detachment of the lower portion of the preform from the lower part 30 of the die.

Furthermore, this fluid delivered into the cavity of the lower part 30 of the die, can be thermo regulated to suitable temperatures for making a first cooling step of the preform that has just been moulded.

The units that are the subject of the invention can be coupled with the moulding machine to always remain on board it. Alternatively, they are incorporated in shuttles that are movable independently of one another, not coupled with one another and suitable for being moved and operated by the forming machine and thus leaving the machine to follow paths external to it.

The two upper and lower parts of the die can be firmly fixed together.

FIGS. 5 to 13 show an apparatus 1 provided with a plurality of moulds 2 supported peripherally on a carousel 5, rotatable around a rotation axis that can be arranged vertically.

Each mould 2 comprises a half mould 3 and a further half mould 4, arranged to interact along a moulding direction S to obtain a preform from a dose of plastics.

The half mould 3 is drivable by a main actuator 15 to and away from the further half mould 4, in the moulding direction S. The half mould 3 is provided with a die body 131 that is obtained inside a stem 13, with which the main actuator 15 is provided. The die body 131 does not protrude in the moulding direction S in relation to the stem 13 and has, transversely in relation to the moulding direction S, a maximum dimension H that is less than an external diameter L of the stem 13, as shown in FIG. 5.

The stem 13 is movable in the moulding direction S and is provided externally with an external coating portion 61 that at least partially surrounds the die body 131.

The die body 131 is internally provided with a longitudinal cavity 16, laterally delimited by a lateral forming surface 17 with which a coating element 53 is provided. An end element 54 contributes to fixing the coating element 53 to the die body 131 by a shape coupling 57. The end element 54 is kept firmly in contact with a transverse end surface 58 of the die body 131 by a threaded ring nut element 59 that is screwed onto a threaded part 60 with which the external coating portion 61 is provided.

The end element 54 comprises a rest surface 62, arranged transversely in relation to the moulding direction S and facing the further half mould 4. From the rest surface 62 a frustum-conical-shaped annular portion 125 projects upwards, that is provided with a concave surface 136 that is shaped in such a way as to interact with the further half mould 4.

Inside the stem 13, a movable bottom element 132 is housed that is slidable in relation to the die body 131 in the moulding direction S. The movable bottom element 132 is provided with a bottom surface 138, arranged transversely in relation to the moulding direction S and delimiting below the longitudinal cavity 16.

The movable bottom element 132 is drivable by an auxiliary actuator 17, arranged inside the main actuator 15.

The auxiliary actuator 17 comprises a piston 18 that is movable inside a chamber 152 that is connected to a hydraulic circuit 24, by means of a first conduit 156.

A second conduit 155 is furthermore connected to the chamber 152.

The first conduit 156 and the second conduit 155 are arranged at opposite ends of the chamber 152. The piston 18 subdivides the chamber 152 into a first chamber 19, associated with the first conduit 156, and into a second chamber 22, associated with the second conduit 155, as better shown in FIG. 13. The first conduit 156 send a fluid, for example pressurised oil, into the chamber 152, in particular into the first chamber 19, in such a way that the movable bottom element 132 can shift from a retracted position to a forming position, in which it is lifted up towards the further half mould 4, so as to complete forming of an object. When forming has finished the second chamber 22 is supplied with oil by the second conduit 155, the aforementioned oil pushing the movable bottom element 132 again towards the retracted position.

With the first conduit 156 a throttle device 27 is associated, shown schematically in FIG. 17, that enables the oil flow to be regulated that enters and exits from the first chamber 19, and accordingly also the speed to be regulated with which the piston 18 is shifted from the retracted position to the forming position, and vice versa. The throttle device 27 comprises a first conduit portion 28, that conveys the oil from a first zone B to a second zone C, a second conduit portion 29 that conveys the oil from the second zone C to a third zone D, a third conduit portion 38, that conveys the oil from the third zone D to a fourth zone E, a fourth conduit portion 39, that conveys the oil from the fourth zone E to a fifth zone F and a fifth conduit portion 40, which conveys the oil from the fifth zone F to a sixth zone G, near the first conduit 156.

The second zone C and the fifth zone F are connected together by a sixth conduit portion 44. The throttle device 27 comprises a calibrated hole 45, obtained in a body arranged in the third conduit portion 38, and a check valve 46, arranged along the sixth conduit portion 44. The check valve 46 and the calibrated hole are arranged parallel to each other.

By substituting the aforementioned body with a further body in which a further calibrated body is obtained of different dimensions from those of the calibrated hole 45 it is possible to vary the oil flow rate and thus the shift speed of the movable bottom element 132, for example to adapt to the features of the plastics that have to be moulded.

The hydraulic circuit 24 has a control unit provided with a slide valve that is able to switch the hydraulic circuit 24 from a high-pressure operational configuration to a low-pressure operational configuration.

During operation, the hydraulic circuit 24, in the high-pressure operational configuration, supplies the first chamber 19 with oil at a first pressure value. The oil is forced to flow from the first zone B to the sixth zone G traversing in sequence the first conduit portion 28, the second conduit portion 29, the third conduit portion 38, the fourth conduit portion 39 and lastly the fifth conduit portion 40. The check valve 46 prevents the oil from flowing from the second zone C to the fifth zone F through the sixth conduit portion 44, but enables the oil to advance only in the direction that goes from the fifth zone F to the second zone C, as will be disclosed below in greater detail.

In the third conduit portion 38, the oil meets flowing resistance through the calibrated hole 45 that depends on the diameter of the latter. In this way, the oil flow rate that traverses the calibrated hole 45 takes on a preset value to which a driving speed of the piston 18 and therefore of the movable bottom element 132 corresponds. This enables movement of the movable bottom element 132 to be controlled so that it can interact with the plastics to be moulded without subjecting them to major stress.

The aforementioned first pressure value is such as to contrast the thrust generated by the oil contained in the second chamber 22, the oil being at a second pressure value that is lower than the aforementioned first pressure value. In this way, whereas the first chamber 19 is filled by lifting up the piston 18, the second chamber 22 is emptied of the oil.

The oil pressure that supplies the chamber 22 is kept substantially constant during operation in such a way that the chamber 22 and the oil arranged to supply the chamber act as a hydraulic spring.

At the end of the forming operation, the chamber 19 is placed in empty status. At this point, the second chamber 22 is again filled with oil in such a way as to again place the movable bottom element 132 in the retracted position.

When the first chamber 19 is placed in empty status, the oil contained inside it again travels along the fifth conduit portion 40 and, subsequently, the sixth conduit portion 44, through the check valve 46. The check valve 46, unlike the calibrated hole 45, enables the passage of a large flow rate of oil in the advance direction that goes from the fifth zone F to the second zone C, and accordingly also the movable bottom element 132, together with the piston 18, can move from the forming position to the retracted position at a speed that is significantly greater than the speed with which it moves from the retracted position to the forming position. This enables mould 2 opening operations and extraction operations of the preform that has just been formed from the mould 2 to be made faster.

It is possible to provide for the hydraulic circuit 24 forming part of a main circuit that drives the main actuator 15 and the oil inside the second chamber 22 being kept at the pressure that is the same as the pressure in the main actuator 15.

FIG. 18 shows a version of the throttle device 27 comprising first conduit means 161 with which a calibrated hole 45 is associated and second conduit means 162 with which a check valve 46 is associated. The first conduit means 161 and the second conduit means 162 are connected in parallel to each other.

The throttle device 27 comprises a body 163 received inside a cavity 164 obtained in a block 165 in such a way that between the block 165 and the body 163 third conduit means 166 connected with both the first conduit means 161 and with the second conduit means 162 are defined.

The second conduit means 162 is obtained in the body 163. The third conduit means 166 has an annular section.

In the body 163 a seat 167 is obtained inside which there is housed a valve body 168 of the check valve 46 and a closing element 169 that closes the seat 167, between the valve body 168 and the closing element 169 there being interposed a spring 173 that keeps the check valve 46 in a closed configuration W, in which a shutter 170, with which the valve body 168 is provided, shuts a hole 171 obtained in the body 163.

In the body 163 fourth conduit means 172 is furthermore obtained.

The first conduit means 161 and the fourth conduit means 172 are permanently connected together by the calibrated hole 45. The second conduit means and the fourth conduit means 172 are connected together when the check valve 46 is in an open configuration, that is not shown, in which the shutter 170 is distanced from the hole 171.

In operation, when the hydraulic circuit 24 is in the high-pressure operational configuration, the oil coming from the third conduit means 166 supplies the first conduit means 161 and the second conduit means 162.

The oil goes from the first conduit means 161 to the fourth conduit means 172 through the calibrated hole 45, the dimensions of the calibrated hole defining the flow rate of oil that reaches the fourth conduit means 172 and accordingly the speed of the movable bottom element 132.

The oil does not go from the second conduit means 162 to the fourth conduit means 172 inasmuch as the check valve is in the closed configuration W.

In addition, a part of the oil coming from the second conduit means 162 occupies a chamber 174 obtained in the valve body 168 so as to press the valve body 168 towards the hole 171, contributing to maintaining the check valve in the closed configuration W.

When the hydraulic circuit 24 is placed in empty status, the oil in the fourth conduit means 172 overcomes the resistance of the spring 173 inducing the check valve 46 to go from the closed configuration W to the open configuration.

In this way, a prevalent portion of the oil in the fourth conduit means 172 goes into the second conduit means 162 through the hole 171, whereas only a small portion of the oil in the fourth conduit means 172 goes into the first conduit means 161 through the calibrated hole 45.

As a result, the movable bottom element 132 is moved towards the punch 111 at low speed, in such a way as not to damage the plastics, and is moved away from the punch 111 at high speed.

As shown in FIGS. 5, 7, 9, 11, 14 and 15, the half mould 3 is provided below with an activating element 47, fixed to the stem 13, at an end of the stem 13 opposite a further end with which the die body 131 is associated.

The activating element 47, for example a magnet element, cooperates with a plurality of detecting elements 80 arranged on the outside of the carousel 5 and angularly distanced from one another.

The detecting elements 80 are arranged at fixed angular positions in such a way as to interact with the activating element 47 during rotation of the carousel 5. Each of the detecting elements 80 is arranged for detecting the height of the activating element 47 at a preset angular position of the carousel 5.

In the version shown in FIG. 15, a first detecting element 80a is arranged in a first position P1 and a second activating element 80b is arranged in a second position P2, distanced from the first position P1 by a preset angular distance.

The detecting elements 80 may comprise magnetostrictive transducers arranged substantially parallel to the moulding direction S in such a way as to detect shifts of the activating element 47—and thus of the stem 13 to which the activating element 47 is fixed—in the moulding direction S. The aforementioned magnetostrictive transducers have detection directions substantially contained in diametric planes of the carousel 5.

The aforementioned magnetostrictive sensors may have a dimension that is at least the same as the stroke performed by the stem 13.

The activating element 47 is intercepted by the detecting elements 80 that are able to send information to a control unit on the position that the stem 13, and therefore the half mould 3, take on in the moulding direction S, when the carousel 5 is in preset angular positions.

This information is processed and compared with theoretical position values stored in the control unit.

This enables the shift of the half mould 3 to be monitored and any malfunctions or faults to be identified that occur during the operations of moving the half moulds towards each other and during forming operations.

During rotation of the carousel 5, the detecting elements 80 interact in succession with all the activating elements 47 and consequently detect the position of all the half moulds 3 at the angular positions of the carousel in which they are located.

The greater the number of detecting elements 80 associated with the carousel 5, each arranged in a respective angular position, the greater is the degree of detail with which the shift of the stem 13 can be monitored.

Alternatively, it is possible to provide a number of detecting elements 80 that is the same as the number of activating elements 47, i.e. as the number of half moulds 3.

In this case, the detecting elements can be fitted on board the carousel 5 in such a way that each activating element 80 cooperates with a respective activating element 47.

It is possible to provide a mould in which the further half mould 4 is movable towards and away from the half mould 3, which is kept in a fixed position, or it is possible to provide for the half mould 3 and the further half mould 4 both being movable; in such cases a further activating element can be provided fixed to the further half mould 4 and cooperating with further detecting elements, in such a way as to supply to the control unit information on the position that the further half mould 4 takes on during rotation of the carousel 5.

As shown in the FIGS. 5 to 14, to the auxiliary actuator 17 a rod element 48 is fixed below that can slide axially—together with the movable bottom element 132—in relation to the stem 13. The rod element 48 protrudes below the outside of the stem 13 and is provided below with a further activating element 49, arranged to cooperate with a plurality of further detecting elements 90, for example optical or inductive detecting elements arranged in a fixed position in relation to the carousel 5 and spaced angularly apart from one another.

In the version shown in FIG. 16, a first further detecting element 90a is arranged in a third position P3, a second further activating element 90b is arranged in a fourth position P4, distanced from the further first position P3 by a preset angular distance and a fifth further activating element 90c is arranged in a fifth position P5, distanced from the fourth position P4 by a further preset angular distance.

The further detecting elements 90 can be arranged below the carousel 5 in such a way as to detect shifts of the further activating element 49—and therefore of the movable bottom element 132 to which the further activating element 49 is fixed by the rod element 48—in the moulding direction S. The further detecting elements 90 have further detection directions arranged substantially parallel to the moulding direction S.

As disclosed above, the further detecting elements are arranged in fixed angular positions in such a way as to detect the height of the further activating element 49 in various positions whilst the carousel 5 rotates.

The further activating element 49 is detected by the further detecting elements, which enable information to be sent to a control unit on the position that the auxiliary actuator 17 assumes when the carousel 5 is in preset angular positions.

In a version, a first further detecting element can be provided that is arranged to detect whether the further activating element 49 has reached an end-of-stroke position corresponding to the forming position of the movable bottom element 132, in which the piston 18 is brought up against an abutment obtained in the stem 13.

If the first further detecting element detects that the further activating element 49 has not reached the end-of-stroke position, the quantity of plastics received inside the die body is greater than a theoretical quantity.

In this case, the preform obtained may seem to be unacceptable.

A second further detecting element may be furthermore provided, positioned upstream of the first detecting element in relation to the rotation direction of the carousel, arranged for detecting an intermediate position of the further activating element, corresponding to a position of the movable bottom element 132 interposed between the retracted position and the forming position.

If the second further detecting element detects that the further activating element 49, in the aforementioned intermediate position, is arranged at a preset height, the quantity of plastics inserted inside the die body corresponds to the theoretical quantity.

Alternatively, if the second further detecting element detects that the further activating element 49, in the aforementioned intermediate position, is arranged at a lower height than the preset height, the quantity of plastics received inside the die body is greater than a theoretical quantity.

Still alternatively, if the second further detecting element detects that the further activating element 49, in the aforementioned intermediate position, is arranged at a greater height than the preset height, the quantity of plastics received inside the die body is less than a theoretical quantity.

A quantity of plastics that is less than a theoretical quantity cannot be detected by the first further detecting element alone, inasmuch as the movable bottom element 132 reaches the forming position even if the plastics have not filled the die body appropriately.

In this case, providing the second further detecting element enables detecting that, at a position preceding the one in which the movable bottom element 132 has reached the end-of-stroke position, the further detecting element has traveled a distance greater than the prescribed distance.

The aforesaid greater distance, depending on less resistance encountered by the movable bottom element 132 in its movement in relation to the die body 131, indicates that the quantity of plastics in the die body 131 is less than the aforesaid theoretical quantity.

In other words, the second further detecting element enables it to be detected that the movable bottom element 132, during a rotation of the carousel by an angle greater than the preset angular amplitude, approached the punch 111 by more than what is theoretically envisaged due to the scarcity of plastics inside the die body 131.

If there is provided more than two further detecting devices, each of which is arranged in a respective angular position, it is possible to detect, by means of the further activating element 49, the height of the movable bottom element 132 in a plurality of intermediate positions between the retracted position and the forming position.

In this way, it is possible to improve the precision with which the shift of the movable bottom element 132 can be monitored.

More precise information regarding the quality of the preforms being moulded can be accordingly deduced.

With the further detecting elements storing elements are associated that store the data detected by the further detecting elements to enable them to be processed and statistically checked, and rejection of preforms that do not fall within acceptable limits.

These acceptability range can be set by fixing the tolerances within which the positions detected by the further detecting elements can deviate from reference positions.

Alternatively, it is possible to provide a number of further detecting elements 90 that are the same as the number of further activating elements 49, i.e. as the number of half moulds 3.

In this case, the further detecting elements 90 may be fitted on board the carousel 5 in such a way that each further activating element 90 cooperates with a respective further activating element 49.

The further half mould 4, as better shown in FIGS. 8, 10 and 12, comprises a support element 107 provided with a cavity delimited by a wall 100. Inside the aforementioned cavity a fixing body 108 is housed centrally by means of which a punch 111 is associated with the support element 107. Inside the cavity of the support element 107 an internal transverse surface 112 is provided to which a fixed-sleeve element 110 is fixed that is coaxial with the moulding direction S. The fixed-sleeve element 110 is provided below with an abutment portion 119 that protrudes radially in relation to the moulding direction S towards the wall 100. Between the fixed-sleeve element 110 and the wall 100 a movable sleeve element 64 is housed that is slidable in the moulding direction S. The movable sleeve element 64 comprises a first operating surface 115 above, facing the transverse surface 112 and distanced from the latter by a variable amount depending on the position of the movable sleeve element 64 inside the support element 107. In this way the first operating surface 115, an internal surface of the wall 100 and an external surface of the fixed-sleeve element 110 define an upper chamber 116 having a height, measured in the moulding direction S, that is variable in function of the position of the movable sleeve element 64.

The movable sleeve element 64 is provided below with a surface shaped to rest on the abutment portion 119 of the fixed-sleeve element 110. The movable sleeve element 64 is provided with an appendage 121 comprising a second operating surface 122 that is transverse in relation to the moulding direction S. The appendage 121 is able to position itself in such way as to arrange the second operating surface 122 at a lower height than the abutment portion 119.

The upper chamber 116 is supplied with a fluid, for example compressed air, in such a way as to push downwards the movable sleeve element 64 against the abutment portion 119. The further half mould 4 furthermore comprises a maintaining sleeve 114 partially housed inside the support element 107 and arranged in such a way as to partially surround the punch 111.

The maintaining sleeve 114 is provided with a contact surface 126 that is transverse in relation to the moulding direction S and is suitable for interacting with the second operating surface 122.

The maintaining sleeve 114 is slidable in relation to the punch 111 parallel to the moulding direction S and below comprises a frustum-conical coupling portion 124. Between the wall 100, the maintaining sleeve 114, the fixed-sleeve element 110 and the movable sleeve element 64 a lower chamber 128 is defined, the height of which, measured parallel to the moulding direction S, is variable according to the position of the maintaining sleeve 114 in relation to the support element 107. The lower chamber 128 is supplied with a further fluid, for example compressed air, at pressure that is lower than the pressure in the upper chamber 116.

The maintaining sleeve 114 is provided with a rest portion 133, shaped so as to be supportingly received on an abutment element 134, fixed below the wall 100.

The further pressurised fluid in the lower chamber 128 pushes the maintaining sleeve 114 downwards in such a way that the rest portion 133 is in contact with the abutment element 134. The further half mould 4 furthermore comprises a pair of movable die parts 135, that are used to shape a threaded neck of a preform that is provided with undercut zones. The movable die parts 135 are movable towards/away from one another in the moulding direction S. The movable die parts 135 surround at least partially the punch 111 and can move parallel to the moulding direction S in relation to the aforementioned punch.

Each of the movable die parts 135 comprises an internal shaping surface 117, suitable for shaping an external surface of the threaded neck of the preform, and an external frustum-conical surface 137 suitable for interacting with the coupling portion 124.

The movable die parts 135 are delimited below by a transverse coupling surface 157, arranged transversely in relation to the moulding direction S and configured to interact with the half mould 3.

The transverse coupling surface 157 is surrounded by an annular surface 160, frustum-conical in shape, that is suitable for interacting with the half mould 3.

The movable die parts 135 are provided above with abutment portions 77, that can be brought up against rest zones 78 of the punch 111.

A carriage is provided that is not shown that supports the movable die parts 135 that is movable parallel to the moulding direction S. The movable die parts 135 can be shifted from a position of reciprocal contact, in which they form the threaded neck of the preform, to a separation position, in which they are distant from one another to disengage from the threaded neck of the preform, so that the latter can be extracted from the mould 2.

In a version that is not shown it is possible to provide a further half mould 4 that is movable in the moulding direction and a die body 131 that is fixed in relation to the carousel 5, whereas the movable bottom element 132 is movable in relation to the latter in a manner that is similar to what has been disclosed above.

In un further version it is possible to provide a half mould 3 and a further half mould 4, both of which are movable in the moulding direction S.

During operation, the half mould 3 and the further half mould 4 are initially far from each other to enable a dose of plastics to be inserted inside the longitudinal cavity 16, as shown in FIG. 5.

The movable bottom element 132 is in the retracted position. The movable die parts 135 are in contact with one another and with the maintaining sleeve 114 that is pressed against the abutment element 134 by the pressurised air contained in the lower chamber 128.

Subsequently, the stem 13 of the main actuator 15 advances the half mould 3 towards the further half mould 4 in the moulding direction S. At a given instant, shown in FIGS. 9 and 10, the die body 131 comes into contact with the movable die parts 135. The punch 111 is received inside the longitudinal cavity 16, interacting with the dose contained inside it, that flows towards the movable die parts 135.

Whilst the half mould 3 continues to advance towards the further half mould 4, the die body 131 pushes the movable die parts 135 upwards, which in turn lift up the maintaining sleeve 114, which compresses the pressurised air contained in the lower chamber 128. The pressurised air keeps the maintaining sleeve 114 in contact with the movable die parts 135, in such a way that the coupling portions 124 exert on the frustum-conical surfaces 137 a clamping force that is sufficient to keep the movable die parts 135 joined together. Subsequently, as the half mould 3 continues to approach the further half mould 4, the maintaining sleeve 114 interacts with the movable sleeve element 64 and pushes it to the internal transverse surface 112, compressing the air contained in the upper chamber 116. Simultaneously, the plastics flow near the shaping surfaces 117, progressively generating the threaded neck of the preform.

The movable die parts 135, and therefore also the maintaining sleeve 114, finish their upward stroke when the abutment portions 77 meet the rest portions 78, as shown in FIGS. 11 and 12. Only when the punch 111 has been received inside the longitudinal cavity 16 by a maximum amount, or almost, is the movable bottom element 132 shifted by the auxiliary actuator 17 in such a way as to promote the flow of the plastics near the shaping surfaces 117.

In this step, the slide valve of the aforementioned control unit switches the hydraulic circuit 24 from the low-pressure operational configuration to the high-pressure operational configuration, in the high-pressure configuration the pressure in the first chamber 19 being greater than the pressure—substantially constant—in the second chamber 22. Only in this step, in fact, is the movable bottom element 132 shifted to compress the plastics.

Previously, the hydraulic circuit 24 can be kept in the low-pressure configuration, inasmuch as the half mould 3 is in the step of moving towards the half mould 4, but compression of the plastics received inside the die body 131 has not yet started.

In a version, the high-pressure operational configuration is set up when the mould 2 is in a clamped end-of-stroke configuration in which the transverse coupling surface 157 is come to rest against the rest surface 62 and the movable die parts 135 are in contact with the rest zones 78.

Alternatively, switching between the low-pressure operational configuration and the high-pressure operational configuration can occur before the mould has reached the clamped end-of-stroke configuration, in such a way as to anticipate the shift of the movable bottom element 132.

In particular, the set up of the high-pressure operational configuration—and consequently driving of the movable bottom element 132—can occur when a prevalent portion of the punch 111 has been received inside the die body 131. The maintaining sleeve 114 keeps the movable die parts 135 joined together with a further clamping force that is greater than the aforementioned clamping force, through the effect of the pressure of the air in the upper chamber 116, which is noticeably greater than that in the lower chamber 128. The stroke of the components that make up the further half mould 4, and in particular of the maintaining sleeve 114 and of the movable sleeve element 64, is sized in such a way that the air contained in the upper chamber 116 starts to be compressed when the plastics have arrived near the movable die parts 135. In this way, the clamping force increases only when it is actually necessary, namely when the plastics tend to separate the movable die parts 135 from one another.

The movable bottom element 132 is moved towards the punch 111 according to the manner of operation that has been disclosed above in detail. The movable bottom element 132 is moved towards the punch 111 by an amount that depends on the volume of the dose, which may be subject to variations connected with the dosing operations and to successive variations connected to heat shrinkage phenomena.

After the preform has remained inside the mould 2 for a period of time required for it to cool sufficiently and its shape to stabilise, the half mould 3 is moved away from the further half mould 4. The punch 111 is partially disengaged from the preform that has just been shaped whereas the movable die parts 135 remain joined together by means of the maintaining sleeve 114 and retain the preform by means of undercut parts obtained on the threaded neck.

Whilst the half mould 3 is disengaged from the further half mould 4, the movable die parts 135, together with the maintaining sleeve 114, are moved away from the support element 107 through the effect of the pressure of the air contained respectively in the upper chamber 116 and in the lower chamber 128.

Subsequently, the movable die parts 135 are moved downwards so as to disengage from the maintaining sleeve 114.

At this point the preform can be extracted from the mould 2 and be conveyed to a successive processing station.

The speed at which the die body 131 is moved towards the further half mould 4 varies according to the position of the latter in relation to one another. In particular, this speed is high in the initial steps in which the half mould 3 is far from the further half mould 4. From the moment at which the rest surface 62 touches the transverse coupling surface 157 until the complete closure of the mould 2, the speed of the half mould 3 is reduced by adjusting the flow of the oil that drives the stem 13. Furthermore, the aforementioned speed is also reduced by the effect of the contrasting thrusts generated by the pressurised air contained in the upper chamber 116 and in the lower chamber 128. This enables the closing operations of the mould 2 to be accelerated, thus avoiding undesired blows between the half mould 3 and the further half mould 4 that may cause undesired blows and generate imprecision in the preform obtained.

1-86. (canceled)

87. Method, comprising compression-moulding plastics to obtain objects by a moulding apparatus, said moulding apparatus being provided with a punch device and with a die device, said die device comprising a die body (and a bottom element mutually cooperating to define a portion of a forming cavity, said moulding comprising reciprocally moving said die device and said punch device, wherein the method furthermore comprises driving said bottom element independently of said punch device and of said die device.

88. Method according to claim 87, wherein before said driving there is provided moving said punch device and said die body towards each other by a preset quantity.

89. Method according to claim 88, wherein said moving towards each other comprises inserting into said die body a prevailing portion of said punch device.

90. Method according to claim 88, wherein said inserting comprises closing said moulding apparatus.

91. Method according to claim 87, wherein said driving comprises transferring said bottom element from a rest position, wherein said bottom element is more distant from said punch device, to a forming position, wherein said bottom element is nearer said punch device to define said forming cavity.

92. Method according to claim 87, wherein said driving comprises controlling a shift speed of said bottom element in relation to said die body.

93. Method according to claim 87, wherein said driving comprises moving said bottom element by operating fluid means.

94. Method according to claim 91, wherein said driving comprises moving said bottom element by operating fluid means.

95. Method according to claim 94, wherein said moving comprises forcing said operating fluid means to flow through a calibrated hole member to shift said bottom element from said rest position to said forming position.

96. Method according to claim 95, wherein said moving comprises enabling said operating fluid means to flow through a conduit device having a section that is greater than a further section of said calibrated hole member to shift said bottom element from said forming position to said rest position.

97. Method according to claim 87, wherein during said driving there is provided detecting positions of said bottom element.

98. Method according to claim 88, wherein during said moving towards there is provided detecting positions of said die body.

99. Apparatus for compression-moulding plastics to obtain objects, comprising a die device provided with a die-body device and with a bottom-element device mutually cooperating to define a portion of a forming cavity device, fluid-operating means arranged to reciprocally move said bottom-element device and said die-body device and a passage device arranged to convey said fluid-operating means, said passage device comprising a throttle device.

100. Apparatus according to claim 99, wherein said throttle device comprises a calibrated hole member for regulating a flow of said fluid-operating means.

101. Apparatus according to claim 99, wherein said throttle device comprises a check-valve device arranged to regulate a further flow of said fluid-operating means.

102. Apparatus according to claim 99, wherein said check-valve device and said calibrated hole device are associated respectively with a conduit and with a further conduit, said conduit and said further conduit being arranged parallel to each other.

103. Apparatus according to claim 102, wherein said conduit is obtained in a body element of said throttle device.

104. Apparatus according to claim 103, wherein said further conduit is obtained in said body element.

105. Apparatus according to claim 104, wherein said throttle device comprises a block provided with a cavity in which said body element is received, between said block and said body element there being defined a conduit device communicating with said conduit and with said further conduit.

106. Apparatus according to claim 103, wherein said body element comprises a seat device inside which a valve-body element of said check-valve device is movable.

107. Apparatus according to claim 103, and furthermore comprising a further conduit device obtained in said body element.

108. Apparatus according to claim 107, wherein said further conduit device communicates permanently with said conduit.

109. Apparatus according to claim 107, wherein said further conduit device communicates with said further conduit only when said check valve assumes an open configuration.

110. Apparatus according to claim 99, and furthermore comprising a detecting system arranged for detecting positions of said die device.

111. Apparatus according to claim 110, wherein said detecting system detects said positions along an advancing direction of said die device in which said die device moves towards and away from a punch device cooperating with said die device.

112. Apparatus according to claim 110, wherein said detecting device comprises an activating device associated with said die device and cooperating with an intercepting device.

113. Apparatus according to claim 112, wherein said activating device is fixed to a stem member of an actuating unit driving said die device.

114. Apparatus according to claim 99, wherein said die device is arranged on board a carousel arrangement.

115. Apparatus according to claim 114, wherein said die device comprises a plurality of dies associated with said carousel arrangement.

116. Apparatus according to claim 112, wherein said die device is arranged on board a carousel arrangement.

117. Apparatus according to claim 116, wherein said die device comprises a plurality of dies associated with said carousel arrangement.

118. Apparatus according to claim 117, wherein said activating device comprises a plurality of activating elements, each activating element of said plurality of activating elements being associated with a corresponding die of said plurality of dies.

119. Apparatus according to claim 117, wherein said intercepting device is arranged in a fixed position in relation to said carousel arrangement.

120. Apparatus according to claim 119, wherein said intercepting device is arranged laterally in relation to said carousel arrangement.

121. Apparatus according to claim 119, wherein said intercepting device comprises a plurality of intercepting elements (arranged in preset angular positions in relation to said carousel.

122. Apparatus according to claim 118, wherein said intercepting device is arranged on board said carousel arrangement.

123. Apparatus according to claim 122, wherein said intercepting device comprises a plurality of intercepting elements, each intercepting element of said plurality of intercepting elements being associated with a corresponding activating element of said plurality of activating elements.

124. Apparatus according to claim 112, wherein said intercepting device comprises a magnetostrictive intercepting device.

125. Apparatus according to claim 115, and furthermore comprising a further detecting system arranged for detecting further positions of said bottom-element device relative to said die-body device.

126. Apparatus according to claim 125, wherein said further detecting system detects said further positions along a further direction in which said die-body device and said bottom-element device move in relation to one another.

127. Apparatus according to claim 125, wherein said further detecting system comprises a further activating device associated with said bottom body device and cooperating with a further intercepting device.

128. Apparatus according to claim 125, wherein said plurality of dies comprises a plurality of die bodies of said die-body device and a plurality of bottom elements of said bottom-element device.

129. Apparatus according to claim 127, wherein said plurality of dies comprises a plurality of die bodies of said die-body device and a plurality of bottom elements of said bottom-element device.

130. Apparatus according to claim 129, wherein said further activating device comprises a plurality of further activating elements, each further activating element of said plurality of further activating elements being associated with a corresponding bottom element of said plurality of bottom elements.

131. Apparatus according to claim 129, wherein said further intercepting device is arranged in a fixed position in relation to said carousel arrangement.

132. Apparatus according to claim 131, wherein said further intercepting device is arranged below said carousel arrangement.

133. Apparatus according to claim 131, wherein said further intercepting device comprises a plurality of further intercepting elements arranged in preset angular positions in relation to said carousel arrangement.

134. Apparatus according to claim 130, wherein said further intercepting device is arranged on board said carousel arrangement.

135. Apparatus according to claim 134, wherein said further intercepting device comprises a plurality of further intercepting elements, each further intercepting element of said plurality of further intercepting elements being associated with a corresponding further activating element of said plurality of further activating elements.

136. Apparatus according to claim 127, wherein said further activating device is fixed to a rod member extending inside an actuating unit driving said die device.

137. Apparatus according to claim 136, wherein said further activating device is associated with an end of said rod member that projects from said actuating unit.

138. Apparatus, comprising a mould device arranged for compression-moulding plastics to obtain objects, said mould device being provided with a half-mould device and with an actuating unit for moving said half-mould device, wherein the apparatus furthermore comprises a detecting system arranged for detecting positions of said half-mould device.

139. Apparatus according to claim 138, wherein said detecting system detects said positions along an advancing direction of said half-mould device in which said half-mould device moves towards and away from a further half-mould device of said mould device.

140. Apparatus according to claim 138, wherein said detecting system comprises an activating device associated with said half-mould device and cooperating with an intercepting device.

141. Apparatus according to claim 140, wherein said activating device is fixed to a stem member of said actuating unit.

142. Apparatus according to claim 138, wherein said mould device is arranged on board a carousel arrangement.

143. Apparatus according to claim 140, wherein said mould device is arranged on board a carousel arrangement.

144. Apparatus according to claim 143, wherein said mould device comprises a plurality of moulds associated with said carousel arrangement.

145. Apparatus according to claim 144, wherein said activating device comprises a plurality of activating elements, each activating element of said plurality of activating elements being associated with a corresponding mould of said plurality of moulds.

146. Apparatus according to claim 144, wherein said intercepting device is arranged in a fixed position in relation to said carousel arrangement.

147. Apparatus according to claim 146, wherein said intercepting device is arranged laterally relative to said carousel arrangement.

148. Apparatus according to claim 146, wherein said intercepting device comprises a plurality of intercepting elements arranged in preset angular positions relative to said carousel arrangement.

149. Apparatus according to claim 145, wherein said intercepting device is arranged on board said carousel arrangement.

150. Apparatus according to claim 149, wherein said intercepting device comprises a plurality of intercepting elements, each intercepting element of said plurality of intercepting elements being associated with a corresponding activating element of said plurality of activating elements.

151. Apparatus according to claim 140, wherein said intercepting device comprises a magnetostrictive intercepting device.

152. Apparatus according to claim 138, wherein said half-mould device comprises a die-body device and a bottom-element device mutually cooperating to define a portion of a moulding cavity.

153. Apparatus according to claim 152, and furthermore comprising a further detecting system arranged for detecting further positions of said bottom-element device relative to said die-body device.

154. Apparatus according to claim 153, wherein said further detecting system detects said further positions along a further direction in which said die-body device and said bottom-element device move in relation to one another.

155. Apparatus according to claim 153, wherein said further detecting system comprises a further activating device associated with said bottom body device and cooperating with a further intercepting device.

156. Apparatus according to claim 144, wherein said half-mould device comprises a die-body device and a bottom-element device mutually cooperating to define a portion of a moulding cavity.

157. Apparatus according to claim 156, wherein said further detecting system comprises a further activating device associated with said bottom body device and cooperating with a further intercepting device.

158. Apparatus according to claim 157, wherein said plurality of moulds comprises a plurality of die bodies of said die-body device and a plurality of bottom elements of said bottom-element device.

159. Apparatus according to claim 158, wherein said further activating device comprises a plurality of further activating elements, each further activating element of said plurality of further activating elements being associated with a corresponding bottom element of said plurality of bottom elements.

160. Apparatus according to claim 158, wherein said further intercepting device is arranged in a fixed position relative to said carousel arrangement.

161. Apparatus according to claim 160, wherein said further intercepting device is arranged below said carousel arrangement.

162. Apparatus according to claim 160, wherein said further intercepting device comprises a plurality of further intercepting elements arranged in preset angular positions relative to said carousel arrangement.

163. Apparatus according to claim 159, wherein said further intercepting device is arranged on board said carousel arrangement.

164. Apparatus according to claim 163, wherein said further intercepting device comprises a plurality of further intercepting elements, each further intercepting element of said plurality of further intercepting elements being associated with a corresponding further activating element of said plurality of further activating elements.

165. Apparatus according to claim 157, wherein said further activating device is fixed to a rod member extending inside said actuating unit.

166. Apparatus according to claim 165, wherein said further activating device is associated with an end of said rod member that projects from said actuating unit.

167. Apparatus, comprising a mould device arranged for compression-moulding plastics to obtain objects, said mould device being provided with a die-body device and with a bottom-element device reciprocally movable and mutually cooperating to define a portion of a forming cavity, and furthermore comprising a detecting system arranged for detecting positions of said bottom-element device relative to said die-body device.

168. Apparatus according to claim 167, wherein said detecting system detects said positions in a direction in which said die-body device e said bottom-element device move in relation to one another.

169. Apparatus according to claim 167, wherein said detecting system comprises an activating device associated with said bottom body device and cooperating with an intercepting device.

170. Apparatus according to claim 169, wherein said mould device is arranged on board a carousel arrangement.

171. Apparatus according to claim 170, wherein said mould device comprises a plurality of moulds associated with said carousel arrangement, said plurality of moulds comprising a plurality of die bodies of said die-body device and a plurality of bottom elements of said bottom-element device.

172. Apparatus according to claim 171, wherein said activating device comprises a plurality of activating elements, each activating element of said plurality of activating elements being associated with a corresponding bottom element of said plurality of bottom elements.

173. Apparatus according to claim 170, or according to claim 79, wherein said intercepting device is arranged in a fixed position relative to said carousel arrangement.

174. Apparatus according to claim 173, wherein said intercepting device is arranged below said carousel arrangement.

175. Apparatus according to claim 173, wherein said intercepting device comprises a plurality of intercepting elements arranged in preset angular positions relative to said carousel arrangement.

176. Apparatus according to claim 175, wherein said intercepting device is arranged on board said carousel arrangement.

177. Apparatus according to claim 176, wherein said intercepting device comprises a plurality of intercepting elements, each intercepting element of said plurality of intercepting elements being associated with a corresponding activating element of said plurality of activating elements.

178. Apparatus according to claim 169, wherein said activating device is fixed to a rod member extending inside an actuating unit arranged for actuating said die-body device.

179. Apparatus according to claim 178, wherein said activating device is associated with an end of said rod member that projects from said actuating unit.
